(19) United States
(12) Patent Application Publication
(10) Pub. No.: US 2023/0365076 A1
(43) Pub. Date: Nov. 16, 2023

(54) Cladding Part and Method for Producing a Cladding Part

(71) Applicant: Bayerische Motoren Werke Aktiengesellschaft, Muenchen (DE)

(72) Inventors: Thomas AUMANN, Buch am Erlbach (DE); Florian DECHANT, Adlkofen (DE); Johann GASSLHUBER, Buch am Erlbach (DE)

(21) Appl. No.: 18/195,973

(22) Filed: May 11, 2023

(30) Foreign Application Priority Data
May 12, 2022 (DE) 10 2022 111 874.6

(51) Int. Cl. B60R 13/02

(52) U.S. Cl. CPC B60R 13/02

(57) ABSTRACT

A cladding part has a carrier part. A surface of the carrier part is at least in sections covered by a surface cover of knitted material. A predetermined breaking point is configured in the surface cover. A method is provided for producing the cladding part.

### CROSS REFERENCE TO RELATED APPLICATION

This application claims priority under 35 U.S.C. § 119 from German Patent Application No. 102022111874.6, filed May 12, 2022, the entire disclosure of which is herein expressly incorporated by reference.

### BACKGROUND AND SUMMARY

The present invention relates to a cladding part and to a method for producing the cladding part.

In the present-day design of vehicles, surfaces in the vehicle interior, or in the passenger cell of motor vehicles, are provided with decorations so as to generate an appealing visual impression for the vehicle occupant. There are a multiplicity of surface variants (leather, artificial leather, films, textiles) for the interior trim components or cladding parts, which are applied to a carrier by way of different laminating methods. For example, a knitted spacer fabric, a foam backing or a non-woven is currently used as the haptic layer for laminated interior trim components.

It has become an established practice to adhesively bond decorations, which are present in the form of films with a visual appearance of wood or carbon for example, to a plastics material carrier. Moreover, it is also known for skins made from leather or artificial leather to be mounted on carrier structures with the aid of laminating methods, for example press-laminating methods or similar laminating methods, for example without a fixed upper die, so as to generate a visual appearance of leather. In this laminating procedure, the films or the skins are connected in a materially integral manner to the underlying carrier structure with the aid of an adhesive. The heat for activating the adhesive is introduced into the adhesive joint through the skin by way of contact heat via a warm press die of the press-laminating tool, or by means of IR radiation. As a result, the adhesive is activated during the laminating method and connects the film, or the skin, to the carrier structure.

However, owing to the materials used and owing to the production methods used, many of these surfaces have limitations in terms of the potential application of the cladding parts in the vehicle interior.

Proceeding from this prior art, it is the object of the present invention to provide a cladding part, and a method for producing the same, which can be applied for many different specific applications. It is a particular object of the invention to provide an airbag function in a cladding part with a knitted surface.

This object is achieved by a cladding part and by a production method in accordance with the independent claims. Further embodiments are set forth in the dependent patent claims referring back to the above.

In order for this object to be achieved, the invention proposes a cladding part having a carrier part, a surface of the carrier part being at least in sections covered by a surface cover from knitted material. Furthermore, a predetermined breaking point can be configured in the surface cover.

Furthermore, the predetermined breaking point can be configured as a line. The line can comprise straight portions, curved portions, or a combination of straight and curved portions. The profile of the line can have a U-profile shape, for example. As a result, a tear line can advantageously be generated.

The predetermined breaking point can be configured as a weakening of the surface cover.

The surface cover can comprise at least one yarn which runs along the predetermined breaking point in the knitted fabric and has lesser mechanical properties than the other yarns that form the knitted fabric. This offers the advantage that one or a plurality of weaker yarns are knitted into the knitted material already during the production process, the weaker yarns then forming a predetermined line of weakening in the finished surface cover. As a result of the weaker yarn being integrated during the production of the knitted fabric, subsequent weakening processes for generating the initial/predetermined breaking point by way of separate process steps into the interior components, such as for example by laser-machining, cutting, stamping, milling etc., the surface cover, can be eliminated. Moreover, the component is produced in a cost-effective and energy-effective manner, the environmental stress due to the emission of carbon dioxide also being reduced.

The thickness of the surface cover in the region of the predetermined breaking point and the thickness of the surface cover in regions which are adjacent to the region of the predetermined breaking point can be of identical size. The identical material thickness of the surface cover offers the advantage that the predetermined breaking point is invisible. This effect is even reinforced when the color of the surface cover is maintained across the entire surface cover, including the predetermined breaking point.

Alternatively thereto, the predetermined breaking point can also be configured so as to be visible in the knitted structure of the surface cover. As a result, a conscious design element which identifies the predetermined breaking point can be created.

The carrier part can likewise have a predetermined breaking point, the predetermined breaking point and the predetermined breaking point of the surface cover being disposed so as to be substantially mutually parallel, i.e. within technically possible or technically required tolerances.

The cladding part can be configured as an instrument panel, dashboard, door trim, seat trim, or pillar trim.

The cladding part is preferably an interior component for the vehicle interior of a vehicle, such as for example instrument panels, door trims, armrests, central consoles, lockable storage compartments such as glove boxes, etc. Glove boxes can be clad both inside or outside.

In a further aspect, the invention relates to a method for producing a cladding part. The method can comprise at least the following steps:
generating a surface cover from knitted material;
generating a carrier part;
applying the surface cover to at least one portion of a surface of the carrier part.

A predetermined breaking point can be integrated into the surface cover while generating the surface cover.

For producing the predetermined breaking point of the surface cover, while generating the surface cover from knitted material, a yarn can be incorporated into the knitted fabric, the mechanical properties of this yarn being lesser than the mechanical properties of the other yarns of the knitted fabric.

Furthermore, the surface cover can be connected to the carrier part in a materially integral or form-fitting manner.

The cladding part can however also be used for other transport means such as aircraft, ships, trains, etc. It is also conceivable that the cladding part is utilized in furniture or interior design items.

In the context of the invention, a knitted material or knitted fabric is understood to be a planar textile. The knitted fabric can have a plurality of layers and be designed from a front-side knitted fabric and a rear-side knitted fabric, the front-side knitted fabric and the rear-side knitted fabric preferably being in each case produced from a yarn or monofilament. The yarn according to the invention in turn is designed from a multiplicity of filaments. For example, a yarn comprises 50 to 100, in particular 70, filaments. The filaments are preferably made from a plastics material and/or aramid and/or a similar material. A three-dimensional knitted fabric is made three-dimensionally by the special production process thereof, and consequently differs from a two-dimensional flat knitted fabric in terms of handling, manufacturing and also the requirements relating to fastening and processing. A three-dimensional knitted fabric is in most instances made for the cover over a carrier component and advantageously enables processing with reduced or even no cutting waste.

The advantages of the invention mentioned previously in the context of the cladding part also apply without limitation to the method and vice versa.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a perspective view of an exemplary carrier part;

FIG. 2 is a perspective view of an exemplary surface cover; and

FIG. 3 is a sectional view through a cladding part according to an embodiment of the invention.

### DETAILED DESCRIPTION OF THE DRAWINGS

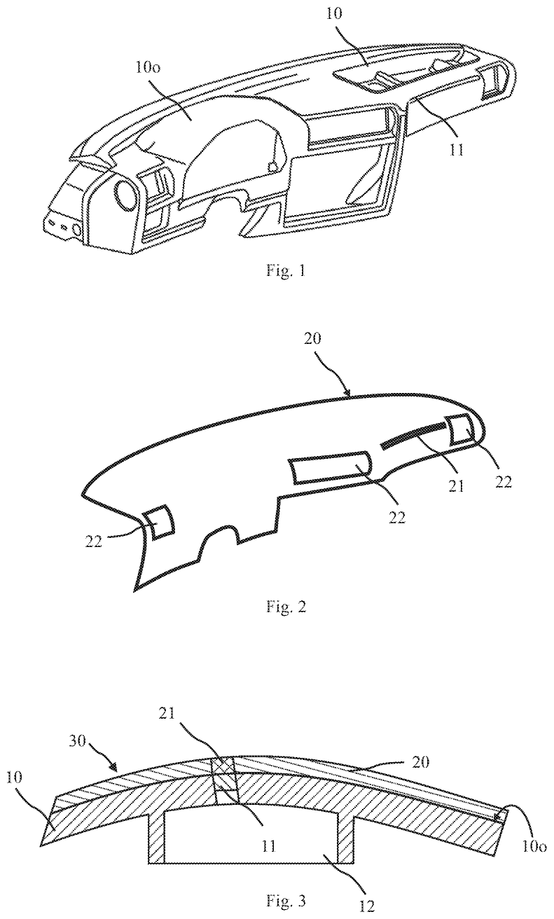

FIG. 1, by way of example, shows an instrument panel carrier 10 which, for purposes of explanation, serves as the carrier part 10. As an alternative to the instrument panel carrier illustrated, all of the cladding parts located in the interior, such as glove boxes, center armrests, central console screens, armrests in the door trims, door trims, headliners, rear consoles, pillar trims, etc., can also serve as the carrier structure 10. This instrument panel carrier 10 has a surface 10o which is to be covered with the aid of a surface cover 20.

As illustrated in FIG. 1, the surface 10o may relate only to one portion, such as for example the upper surface of the hood of the so-called instrument cluster. However, the surface 10o to be covered may also be that part of the surface of the carrier part 10 which would be visible to a vehicle occupant in the interior of the vehicle. Furthermore alternatively, the surface 10o may also comprise the entire surface of the carrier part 10, in which instance regions of the carrier part 10 that are not visible to a vehicle occupant would also be laminated.

The carrier part 10 has a predetermined breaking point 11 which, in FIG. 1, runs in a rectilinear manner in the region of the passenger airbag of the carrier part 10. This predetermined breaking point 11 can be generated, for example, by reducing the material thickness of the carrier part 10. Material here can be selectively subtracted from the surface 10o of the carrier part 10 that points toward the passenger, and/or from a surface of the carrier part 10 that faces away from the passenger.

FIG. 2 shows a surface cover 20 from a knitted material. The surface cover 20 is applied to the surface 10o of the carrier part 10 shown in FIG. 1. The surface cover 20 can be conventionally laminated to the carrier part 10 and thus be connected to the carrier part 10 in a materially integral manner. Alternatively thereto, the surface cover 20 can be fastened to the carrier part in a form-fitting and thus releasable manner by way of fastening elements. As a result, the surface cover 20 is embodied so as to be particularly easily replaceable. The surface cover 20 has a predetermined breaking point 21 which here, in a manner analogous to the predetermined breaking point 11 of the carrier part 10, is configured so as to be rectilinear. Moreover, the surface cover 20 has clearances 22 through which ventilation devices can be routed.

When the surface cover 20 is being applied to the carrier part 10, the predetermined breaking point 21 of the surface cover is applied so as to be congruent with the predetermined breaking point 11 of the carrier part 10 such that the predetermined breaking points 11, 21 in the finished cladding part 30 lie on top of one another, or run so as to be mutually parallel. The carrier part 10 shown in FIG. 3 has an airbag deployment chute 12 which is configured so as to be integral, that is to say in one piece, to the carrier part 10. In further variants not illustrated, the deployment chute can also be configured as a separate part which is connected to the carrier part 10. An airbag, which is not illustrated in more detail in the figures, is triggered in the event of an accident. In the process, the airbag is guided in a defined manner through the predefined path of the deployment chute 12 to a surface of the carrier part 10, the latter facing away from the surface cover 20. There, the airbag then exerts a pressure on the carrier part 10 and the surface material 20. As soon as this pressure exceeds a predetermined threshold value, the predetermined breaking points 11 and 21 are destroyed and the cladding part 30 exposes an opening by way of which the airbag can ideally unfold and protects the occupants.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A cladding part, comprising:
a carrier part; and
a surface cover of a knitted fabric material, the surface cover being configured to cover a surface of the carrier part at least in sections,
wherein a predetermined breaking point is configured in the surface cover.

2. The cladding part according to claim 1, wherein
the predetermined breaking point is configured as a line.

3. The cladding part according to claim 1, wherein
the predetermined breaking point is configured as a weakening of the surface cover.

4. The cladding part according to claim 1, wherein
the surface cover comprises at least one yarn which runs along the predetermined breaking point in the knitted fabric material and has lesser mechanical properties than other yarns that form the knitted fabric material.

5. The cladding part according to claim 1, wherein
a thickness of the surface cover in a region of the predetermined breaking point and a thickness of the surface cover in regions which are adjacent to the region of the predetermined breaking point are of identical size.

6. The cladding part according to claim 1, wherein
the carrier part has a predetermined breaking point, and
the carrier part predetermined breaking point and the predetermined breaking point of the surface cover are disposed so as to be mutually parallel.

7. The cladding part according to claim 1, wherein
the cladding part is configured as an instrument panel, dashboard, door trim, seat trim, or pillar trim, of a vehicle.

8. A method for producing a cladding part, comprising:
generating a surface cover from knitted fabric material;
generating a carrier part;
applying the surface cover to at least one portion of a surface of the carrier part, wherein,
while generating the surface cover, a predetermined breaking point is integrated into the surface cover.

9. The method according to claim 8, wherein,
for producing the predetermined breaking point of the surface cover, while generating the surface cover from knitted fabric material, a yarn is incorporated into the knitted fabric material, mechanical properties of said yarn being lesser than mechanical properties of other yarns of the knitted fabric material.

10. The cladding part according to claim 8, wherein
the surface cover is connected to the carrier part in a materially integral or form-fitting manner.
